(19) United States
(12) Patent Application Publication
(10) Pub. No.: US 2016/0373203 A1
(43) Pub. Date: Dec. 22, 2016

(54) METHOD FOR DISTRIBUTED INTERFERENCE COORDINATION AND SMALL CELL USING THE SAME

(71) Applicant: INDUSTRIAL TECHNOLOGY RESEARCH INSTITUTE, Hsinchu (TW)

(72) Inventors: Chun-Chieh WANG, Kaohsiung City (TW); Tz-An LIN, Hsinchu City (TW); Kuei-Li HUANG, Kaohsiung City (TW)

(73) Assignee: INDUSTRIAL TECHNOLOGY RESEARCH INSTITUTE, Hsinchu (TW)

(21) Appl. No.: 14/741,004

(22) Filed: Jun. 16, 2015

(51) Int. Cl. H04J 11/00; H04B 7/02

(52) U.S. Cl. CPC H04J 11/0053; H04B 7/024

(57) ABSTRACT

A method for distributed interference coordination is provided. The method includes: forming a group of multiple small cells, selecting one of the small cells to be a group leader for the group, and performing time-domain interference coordination on the group by the group leader.

### TECHNICAL FIELD

The disclosure relates in general to interference coordination method, and more particularly to a method for distributed interference coordination and a small cell using the same.

### BACKGROUND

With the growth of mobile communication, in order to provide in-building and outdoor wireless service, mobile operators use small cells to extend their service coverage and increase network capacity. Small cells are radio access nodes having a range of 10 meters to 2 kilometers, as compared to a macrocell having a range of a few tens of kilometers. Examples of small cells include femtocells, picocells, and microcells. In 3rd Generation Partnership Project (3GPP) terminology, a Home Node B (HNB) is a 3G femtocell. A Home eNode B (HeNB) is a Long Term Evolution (LTE) femtocell.

As wireless networks become increasingly dense to accommodate the rising traffic demand, inter-cell interference becomes one of the critical issues. Specifically, with an increasing number of small cells, deployment of small cells becomes denser and thus the distance between small cells becomes shorter. A user equipment (UE), such as a mobile phone, served by an serving cell may suffer from interference caused by a neighboring small cell. For example, when UE is near boundary of the serving cell, signal from neighboring cell acts as interferer. The Signal-to-Noise ratio (SNR) may be poor not only because of the weak signal strength from the serving cell but also because of the interference. Thus there is a need for a method for interference coordination.

### SUMMARY

The disclosure is directed to a method of distributed interference coordination and a small cell using the same.

According to one embodiment, a method for distributed interference coordination is provided. The method includes: forming a group of multiple small cells, selecting one of the small cells to be a group leader for the group, and performing time-domain interference coordination on the group by the group leader.

According to another embodiment, a small cell is provided. The small cell includes a backhaul interface, an air interface, a processing unit, and a storage unit. The backhaul interface connects the small cell to a core network. The air interface connects the small cell to a user equipment. The processing unit configures the small cell in a group in a distributed manner, determines a group leader for the group, and performs time-domain interference coordination on the group. The group includes multiple small cells. The storage unit stores the group leader, a number of small cells in the group, a management capacity of the small cell, and a member list of the group.

### BRIEF DESCRIPTION OF THE DRAWINGS

FIG. 1 shows an example of a distributed self-organizing network.

FIG. 2 shows an example of time-domain interference between small cells.

FIG. 3 shows a process of distributed interference coordination according to an embodiment of this disclosure.

FIG. 4 shows multiple groups formed and group leaders therein according to an embodiment of this disclosure.

FIG. 5 shows a block diagram illustrating a small cell according to an embodiment of this disclosure.

FIG. 6 shows multiple scenarios when forming a group according to an embodiment of this disclosure.

FIG. 7 shows a process of communication between small cells according to an embodiment of this disclosure.

FIG. 8 shows a process of merging two groups according to an embodiment of this disclosure.

FIG. 9 shows a process of group forming under scenario 1 according to an embodiment of this disclosure.

FIGS. 10A and 10B show a process of group forming under scenario 7 according to an embodiment of this disclosure.

FIG. 11 shows a process of forming a group of small cells according to an embodiment of this disclosure.

FIG. 12 shows a process of selecting one of the small cells to be a group leader according to an embodiment of this disclosure.

FIGS. 13A and 13B show a process of splitting one group into two groups according to an embodiment of this disclosure.

FIG. 14 shows a process of group splitting according to an embodiment of this disclosure.

FIG. 15 shows a process of performing time-domain interference coordination on the group according to an embodiment of this disclosure.

FIGS. 16A-16C show an example of determining time-domain interference coordination patterns according to an embodiment of this disclosure.

FIGS. 17A-17C show an example of determining time-domain interference coordination patterns according to different assignment order.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A self-organizing network (SON) is an automation technology designed to make the planning, configuration, management, optimization and healing of mobile radio access networks simpler and faster. Self-organizing networks are commonly divided into centralized SON and distributed SON according to the architecture. In centralized SON (C-SON), functions are typically concentrated to a high level network node, such as a high performance server with enormous computation capacity. On the other hand, in distributed SON (D-SON), functions are distributed among the network elements at the edge of the network, typically HeNB elements.

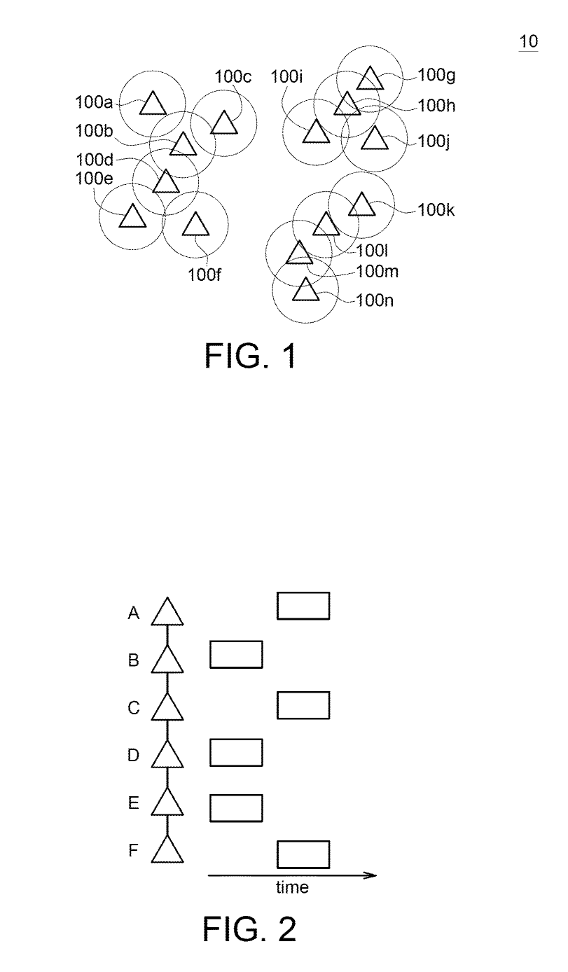

FIG. 1 shows an example of a distributed self-organizing network 10. A number of small cells 100a, 100b, . . . , 100n and the corresponding coverage radio coverage areas are shown in FIG. 1. A center server is not required in the D-SON 10 since SON functions are distributed in small cells 100a-100n. However, each small cell only has a local view. Specifically, each small cell knows the neighbor information but lacks a global overview of the entire network. For example, the small cell 100e knows that it has neighbor cell 100d and cell 100f. However, the small cell 100e does not know the connection relationship between cells 100a, 100b, 100c, and 100d.

In addition, as more and more HeNB are adopted to improve network coverage, small cells are getting closer to each other. UE may suffer from interference between two neighboring small cells. FIG. 2 shows an example of time-domain interference between small cells. The connection relationship between small cells A-F is shown on the left. A line connected between two small cells represent that the two small cells are neighboring to each other. On the right shows the resource block used by each small cell in time-domain, in other words, the time slot used by each small cell. Because the small cell D and the small cell E use the same time slot and these two cells are neighboring to each other, UE served by either cell D or cell E may detect signal interference, which degrades signal transmission quality.

The interference coordination in D-SON may be time-consuming and ineffective due to lack of a global overview of the network. As in the above-mentioned example, if the cell D tries to use the other time slot, it again collides with the cell C. Next, the cell C also has to change the time slot and then collides with the cell B again and so on. There is a need for an efficient method for distributed interference coordination.

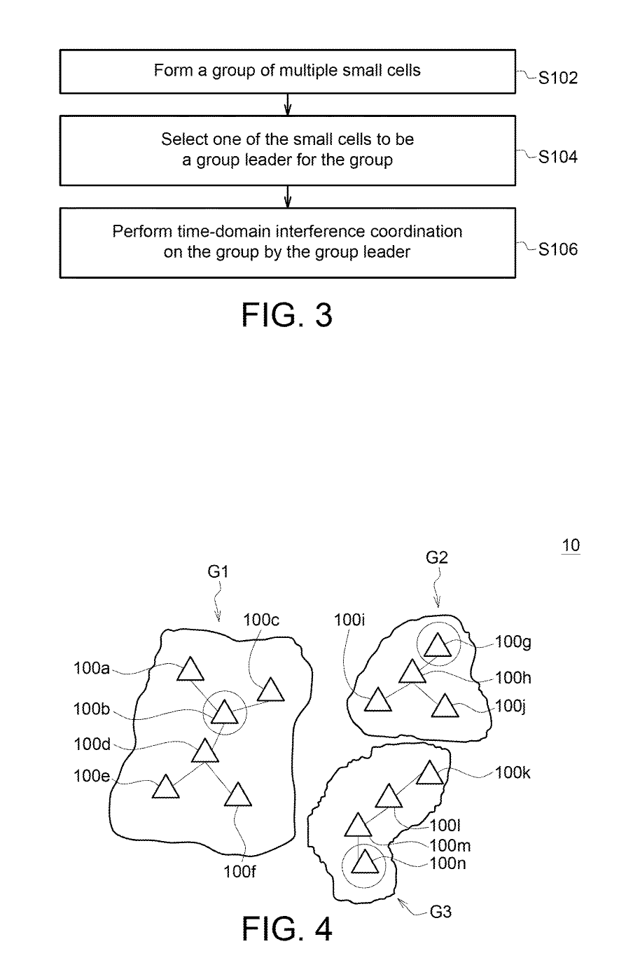

FIG. 3 shows a process of distributed interference coordination according to an embodiment of this disclosure. The process includes the following steps: Step S102 forming a group of multiple small cells. Step S104 selecting one of the small cells to be a group leader for the group. Step S106 performing time-domain interference coordination on the group by the group leader. In this disclosure, the small cells in a distributed SON are formed into groups. A group leader is selected in each group to perform the time-domain interference coordination.

FIG. 4 shows multiple groups formed and group leaders therein according to an embodiment of this disclosure. Take the D-SON 10 in FIG. 1 for example, after performing steps S102-S106 shown in FIG. 3, three groups G1, G2 and G3 are formed. Group G1 includes small cells 100a-100f, wherein the small cell 100b is the group leader of group G1 and thus performs time-domain interference coordination on the group G1. Group G2 includes small cells 100g-100j, wherein the small cell 100g is the group leader of group G2 and performs time-domain interference coordination on the group G2. Group G3 includes small cells 100k-100n, wherein the small cell 100n is the group leader of group G3 and performs time-domain interference coordination on the group G3. The detailed operation of each step will be given in the following description.

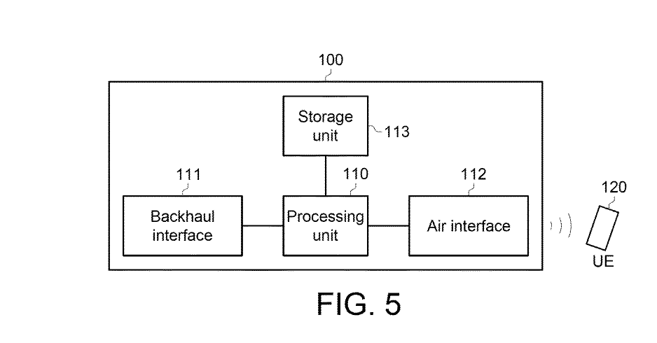

Each small cell 100a-100n in the D-SON 10 may be capable of performing the above mentioned task related to group forming, selecting a group leader, and interference coordination. FIG. 5 shows a block diagram illustrating a small cell 100 according to an embodiment of this disclosure. The small cell 100 includes a processing unit 110, a backhaul interface 111, an air interface 112, and a storage unit 113. The backhaul interface 111 connects the small cell 100 to a core network, such as Evolved Packet Core (EPC) of the LTE system. The small cell 100 is capable of communicating with other small cells via the backhaul interface 111. The backhaul interface 111 may include X2 interface and S1 interface as defined in 3GPP specification. The air interface 112 connects the small cell 100 to a UE 120. The air interface 112 may include an antenna and may be compatible with a variety of technologies, including GSM, CDMA2000, TD-SCDMA, W-CDMA, LTE and WiMax.

The processing unit 110 configures the small cell 100 in a group G0 in a distributed manner, determines a group leader for the group G0, and performs time-domain interference coordination on the group G0, wherein the group G0 includes multiple small cells. The processing unit 110 may be a microprocessor or a microcontroller circuit. The storage unit 113 stores the group leader, the number of small cells in the group G0, a management capacity MC0 of the small cell 100, and a member list of the group G0. The management capacity MC0 represents the maximum number of small cells that the small cell 100 can manage when the small cell 100 is a group leader. The management capacity MC0 may be related to computational capability, available storage space, and operation speed of the small cell 100. The storage unit 113 may be a memory device, such as Random Access Memory (RAM), flash memory, or hard disk drive.

An example of a basic group forming procedure is described as follows. Each small cell 100x has no neighbor when being turned on initially. That is, each small cell 100x is initially a group leader of the group that includes only the small cell 100x itself. In a D-SON, when the small cell 100x detects a new neighbor cell 100y (either detecting by the cell 100x itself or being notified by UE), these two cells 100x and 100y become neighbors. The group including cell 100x and the group including cell 100y are then merged into one merged group. The two group leaders before merging coordinate with each other to determine the new group leader for the merged group. Thus the basic group forming procedure includes neighbor cell discovery and merging two groups.

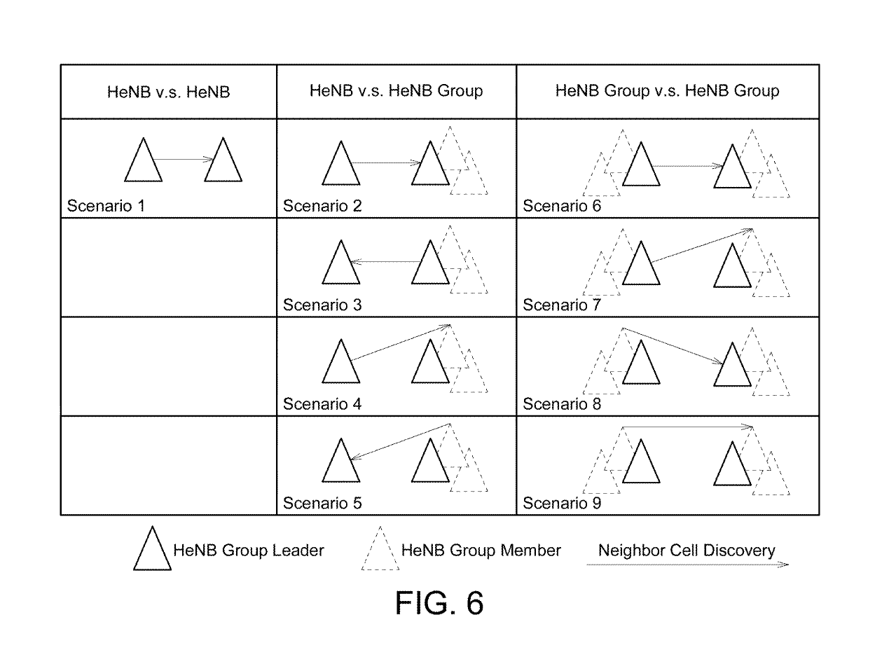

FIG. 6 shows multiple scenarios when forming a group according to an embodiment of this disclosure. All the scenarios include neighbor cell discovery and merging two groups. A solid line triangle represents a group leader while a dashed line triangle represents a group member. The solid arrow represents the direction of neighbor cell discovery. Scenario 1 represents that each of the two original groups includes only one small cell. Scenarios 2-5 represent one HeNB merging with one HeNB group with multiple HeNBs. Scenarios 6-9 represent one HeNB group merging with another HeNB group, each group including multiple HeNBs. The neighbor cell discovery may be between a leader and a leader, a member and a member, or a leader and a member.

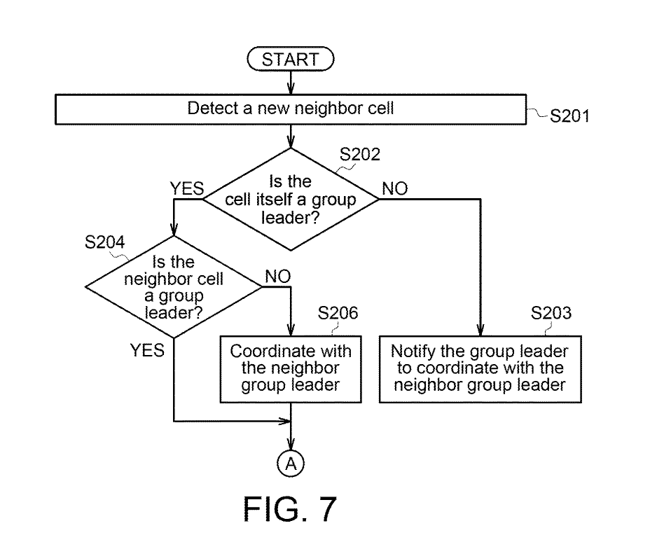

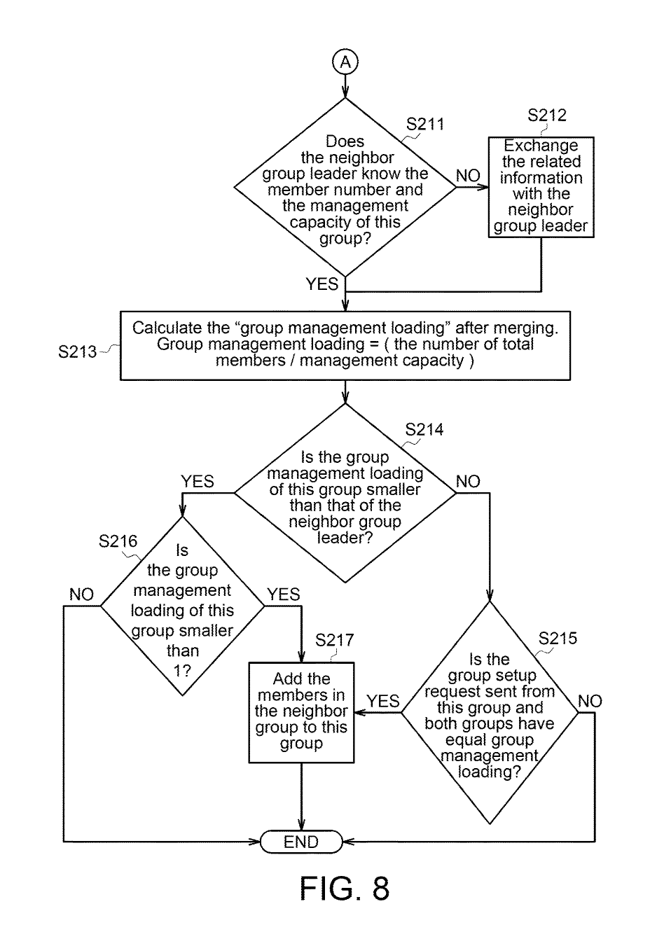

There are multiple scenarios as described above from a system's perspective. From a small cell's perspective, the group forming process is unified as flowcharts shown in FIG. 7 and FIG. 8. FIG. 7 shows a process of communication between small cells according to an embodiment of this disclosure. In step S201, the small cell 100x (in group G1) detects a new neighbor cell 100y (in a neighbor group G2). For example, the small cell 100x may receive a report of detecting the neighbor cell 100y from the user equipment 120 via the air interface 112. Such detection is an automatic neighbor relation (ANR) initiated by the UE 120. The small cell 100x may also detect the neighbor cell 100y in vicinity by itself. The group G1 and the neighbor group G2 will be merged into a merged group Gm. Note that when the small cell 100x detects a new neighbor cell 100y, the small cell 100y is detected as a new neighbor. The process shown in FIG. 7 may also be executed by the small cell 100y to facilitate communication between two small cells. Thus in one embodiment, step S201 may also represent the small cell is detected as a new neighbor cell.

In step S202, check whether the small cell 100x itself is a group leader or not. If not, in step S203, the small cell 100x notifies the group leader via the backhaul interface 111 to coordinate with a neighbor group leader of the neighbor group G2 to determine a merged group leader for the merged group Gm. In this case, the small cell 100x has informed the group leader of the detection of the new neighbor cell. The group leader of the group G1 then performs the following task regarding merging two groups. The small cell 100x itself does not participate in the process of merging two groups, such as the process shown in FIG. 8. On the other hand, if the small cell 100x itself is the group leader, in step S204, the small cell 100x checks whether the neighbor cell 100y is the group leader of the neighbor group G2. If the neighbor cell 100y is not the group leader, the small cell 100y may inform the small cell 100x of the group leader of the group G2. The small cell 100x coordinates with the neighbor group leader via the backhaul interface 111 in step S206 to determine a merged group leader for the merged group Gm. If the neighbor cell 100y is the group leader, the small cell 100x coordinates with the neighbor cell 100y via the backhaul interface 111. Two groups are merged in following steps shown in FIG. 8. In summary, the coordination regarding how two groups are merged is performed by two respective group leaders.

FIG. 8 shows a process of merging two groups according to an embodiment of this disclosure. In step S211, the group leader of group G1 checks whether the neighbor group leader of neighbor group G2 knows the number of members N1 and the management capacity MC1 of the group G1. If not, exchange the related information with the neighbor group leader in step S212. In step S213, a “group management loading” parameter GL1 is calculated. In one embodiment, the group management loading is the number of total members divided by the management capacity. For example, group management loading GL1=(N1+N2)/MC1, N1: number of members in group G1, N2: number of members in group G2, MC1: management capacity of the group leader in group G1. The neighbor group leader calculates its group management loading parameter GL2 as well. In step S214, check whether the group management loading GL1 is smaller than group management loading GL2 of the neighbor group G2. If GL1<GL2, it means that the group leader of group G1 has better management capacity than group leader of group G2. Thus if GL1<1 (step S216), which means the group leader of group G1 will not overload after merging, the group leader of group G1 will be selected as the group leader of the merged group Gm. The members in the neighbor group G2 are added to the group G1 in step S217. The processing unit 110 updates the number of small cells in the group and the member list of the group stored in the storage unit 113 according to the neighbor group G2.

Note that the same procedure is executed by the group leader of the group G2 as well. Therefore if GL2<GL1 and GL2<1, the group leader of group G2 will be selected as the group leader of the merged group Gm. In rare circumstances, both groups may have equal group management loading (GL1=GL2). In this case, select the small cell that sends the group setup request to be the group leader of the merged group Gm (step S215). In some cases the two groups G1 and G2 may fail to be merged together, for example, when both group leader overload after merging (GL1>1 and GL2>1). If this happens due to the insufficient management capacity MC of each group leader, the two groups G1 and G2 remain separated.

According to the flowchart shown in FIG. 8, when the small cell 100x coordinates with the neighbor group leader, the processing unit 110 determines the merged group leader according to the number of small cells in the merged group (N1+N2), a management capacity MC1 of the small cell 100x, and a management capacity MC2 of the neighbor group leader. It should be noted that the flowchart in FIG. 8 is an exemplary process. The actual parameter calculation is not limited thereto. For example, the calculation of group management loading parameter GL may be omitted. In one embodiment, if the management capacity MC1 of the small cell 100x is greater than both the management capacity MC2 of the neighbor group leader and the number of small cells in the merged group N1+N2 (MC1>MC2 and MC1>N1+N2), the processing unit 110 determines the small cell 100x to be the merged group leader.

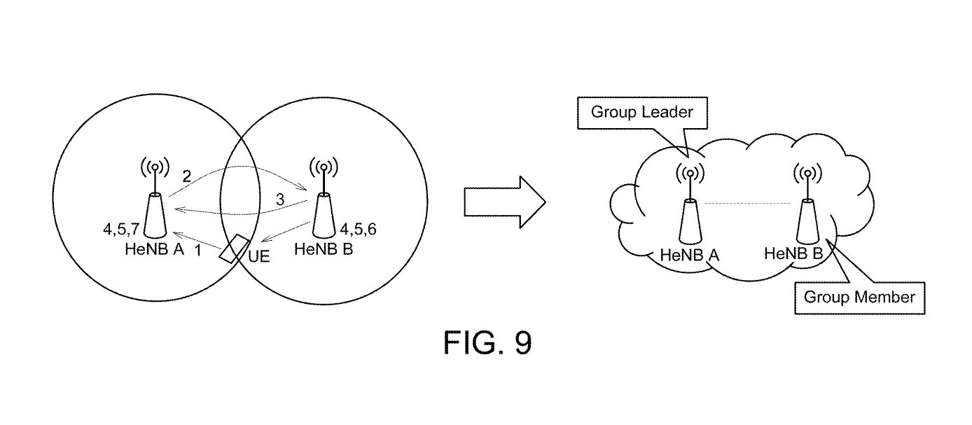

Refer to the multiple scenarios in FIG. 6, the above described group forming process shown in FIG. 7 and FIG. 8 may be applied to all the scenarios. Two such scenarios are described here for examples. FIG. 9 shows a process of group forming under scenario 1 according to an embodiment of this disclosure. Numbers in the figure represent steps executed sequentially in time. Initially HeNB A and HeNB B are the group leaders of the respective group, wherein each group has no other members. Messages between a HeNB and a UE are transmitted via the air interface 112, while messages between two HeNBs are transmitted via the backhaul interface 111. HeNB B is the original serving cell of the UE.

Step 1: HeNB A receives a report of detecting HeNB B from UE. Step 2: HeNB A sends a group setup request (the number of members N1=1, management capacity MC1=5) to HeNB B. Step 3: HeNB B responds with a group setup response (the number of members N2=1, management capacity MC2=5). Step 4: HeNB A and HeNB B determine the new group leader according to the leader selection mechanism. Step 5: HeNB A determines to be the new group leader. HeNB B determines not to be the new group leader. (In this case both group leaders have equal group management loading, thus the group leader is the one that sends the group setup request.) Step 6: HeNB A updates its group member list to incorporate HeNB B. Step 7: HeNB B updates its group leader as HeNB A.

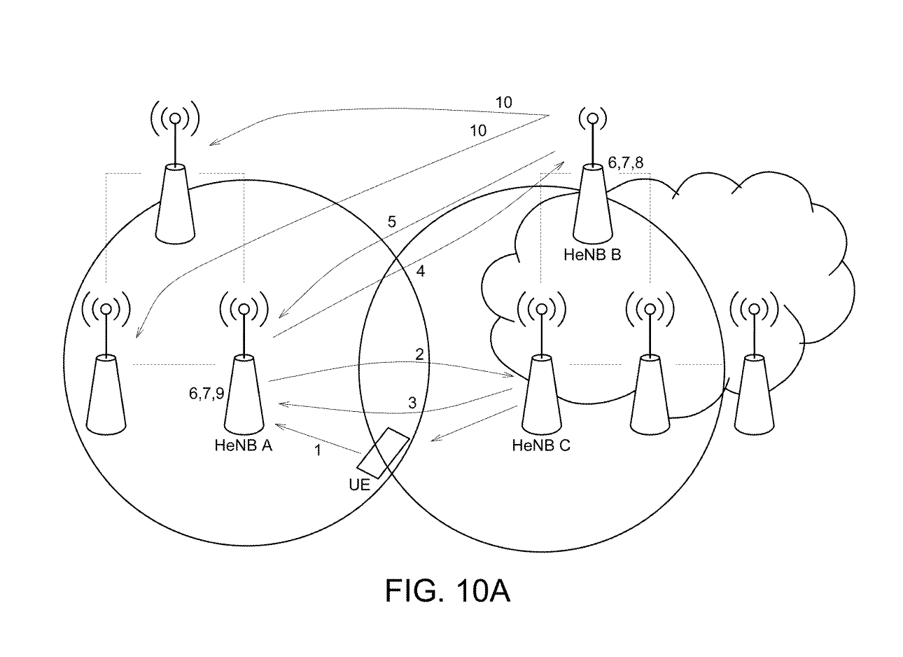

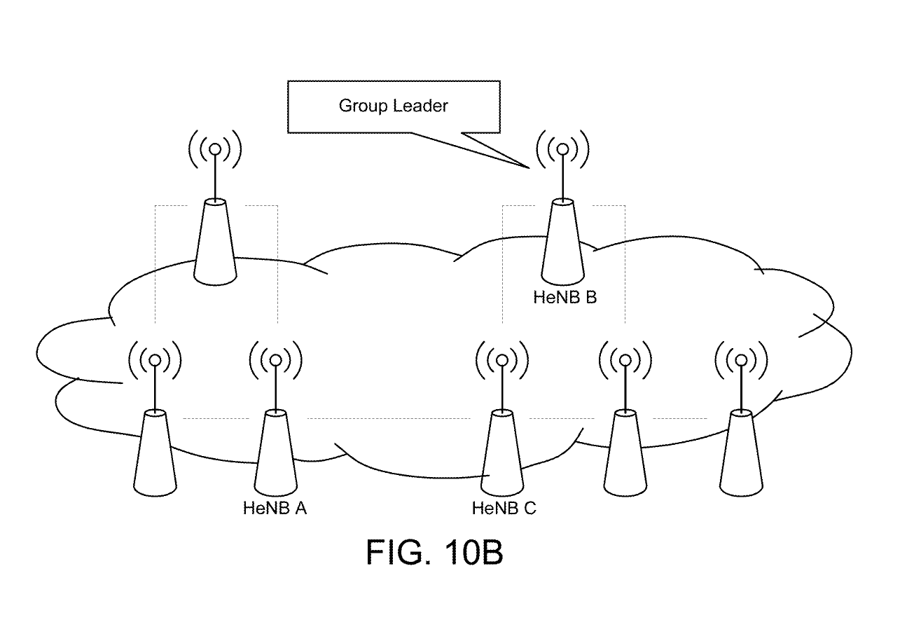

FIGS. 10A and 10B show a process of group forming under scenario 7 according to an embodiment of this disclosure. Initially the left three small cells belong to group G1, and the right four cells belong to group G2. HeNB A is the group leader of group G1, and HeNB B is the group leader of group G2. Step 1: HeNB A receives a report of detecting HeNB C from the UE. Step 2: HeNB A sends a group setup request (the number of members N1=3, the management capacity MC1=10) to HeNB C. Step 3: HeNB C responds with a group setup response (the group leader is HeNB B). Step 4: HeNB A sends a group setup request (the number of members N1=3, the management capacity MC1=10) to HeNB B. Step 5: HeNB B responds with a group setup response (the number of members N2=4, the management capacity MC2=20). Step 6: HeNB A and HeNB B determine the new group leader according to the leader selection mechanism. Step 7: HeNB A determines not to be the new group leader. HeNB B determines to be the new group leader. Step 8: HeNB B updates its group member list to incorporate HeNB A. (In this case MC2>MC1 and HeNB B does not overload after merging.) Step 9: HeNB A updates its group leader as HeNB B. Step 10: HeNB B updates its group member list to incorporate members originally belonging to the group G1. HeNB B notifies the members originally belonging to the group G1 to update their group leader as HeNB B.

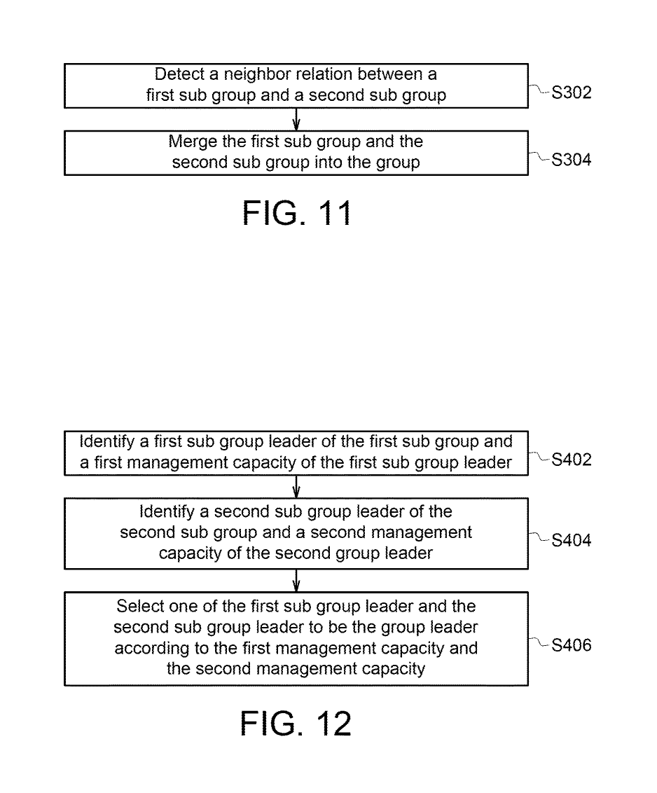

The process flows for other scenarios are similar and thus are not repeated here. The group forming process in the D-SON conforms to the flowcharts shown in FIG. 7 and FIG. 8. From the system's perspective, the group forming process is illustrated in flowcharts in FIG. 11 and FIG. 12. Also refer to FIG. 3 showing the process of distributed interference coordination, step S102 is further described in FIG. 11, and step S104 is further described in FIG. 12.

FIG. 11 shows a process of forming a group of small cells according to an embodiment of this disclosure. As described above, the basic group forming procedure includes neighbor cell discovery and merging two groups. Forming the group of small cells (step S102) may include: detecting a neighbor relation between a first sub group G1 and a second sub group G2 (step S302), and merging the first sub group G1 and the second sub group G2 into the group (step S304).

Detecting a neighbor relation between a first sub group G1 and a second sub group G2 (step S302) may include: detecting a second small cell in the second sub group G2 by a user equipment, and receiving, by a first small cell in the first sub group G1, a report of detecting the second small cell from the user equipment, wherein the first small cell is an original serving cell of the user equipment. That is, the neighbor cell discovery may be an automatic neighbor relation initiated by the UE.

FIG. 12 shows a process of selecting one of the small cells to be a group leader according to an embodiment of this disclosure. Selecting one of the small cells to be the group leader for the group (step S104) may include: identifying a first sub group leader of the first sub group G1 and a first management capacity MC1 of the first sub group leader (step S402), identifying a second sub group leader of the second sub group G2 and a second management capacity MC2 of the second group leader (step S404), and selecting one of the first sub group leader and the second sub group leader to be the group leader according to the first management capacity MC1 and the second management capacity MC2 (step S406). If the first management capacity MC1 is larger than both the second management capacity MC2 and the number of the small cells in the group, the first sub group leader is selected to be the group leader. If the second management capacity MC2 is larger than both the first management capacity MC1 and the number of the small cells in the group, the second sub group leader is selected to be the group leader. The detailed leader selection mechanism, including an embodiment of calculating the group management loading parameter, is described in FIG. 8 and thus is not repeated here.

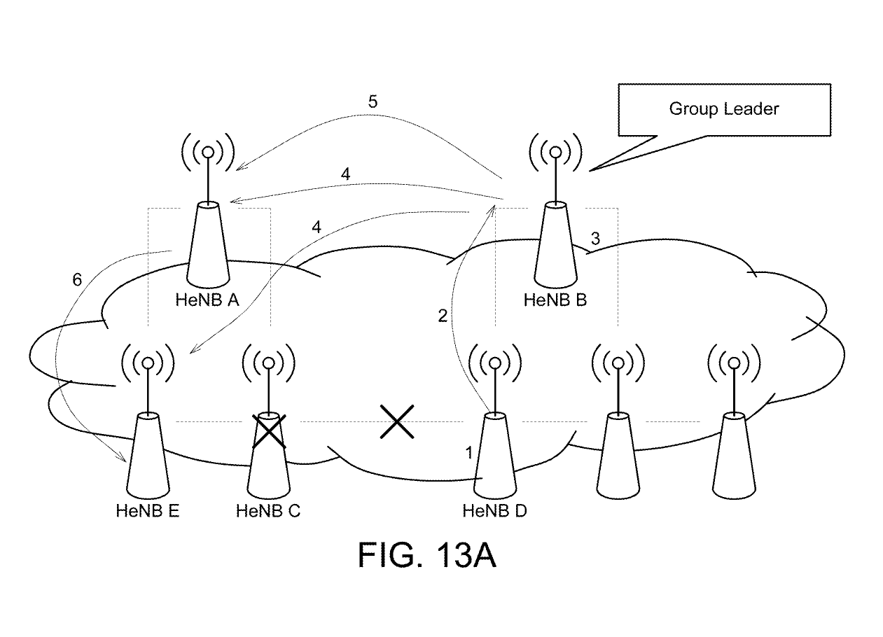

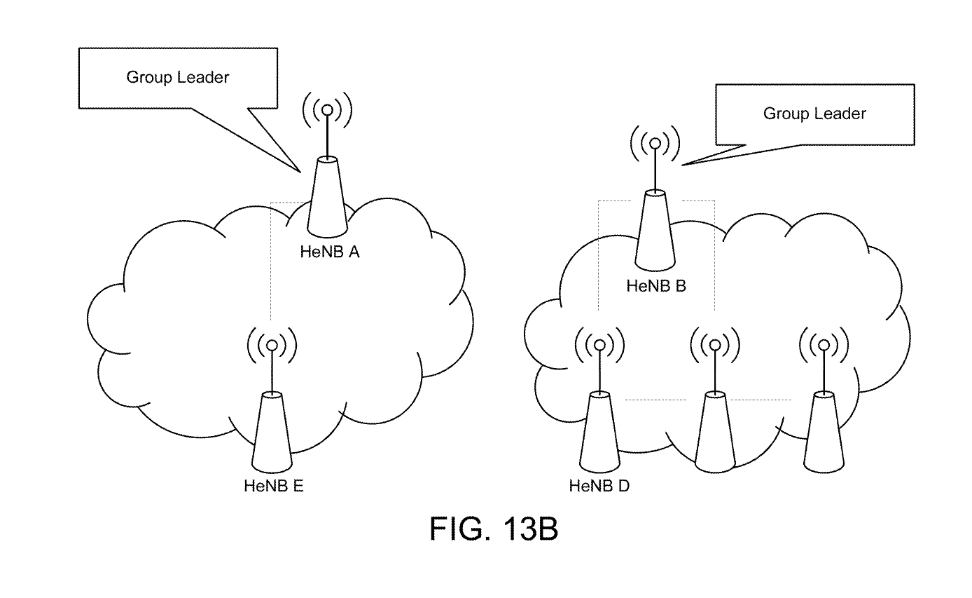

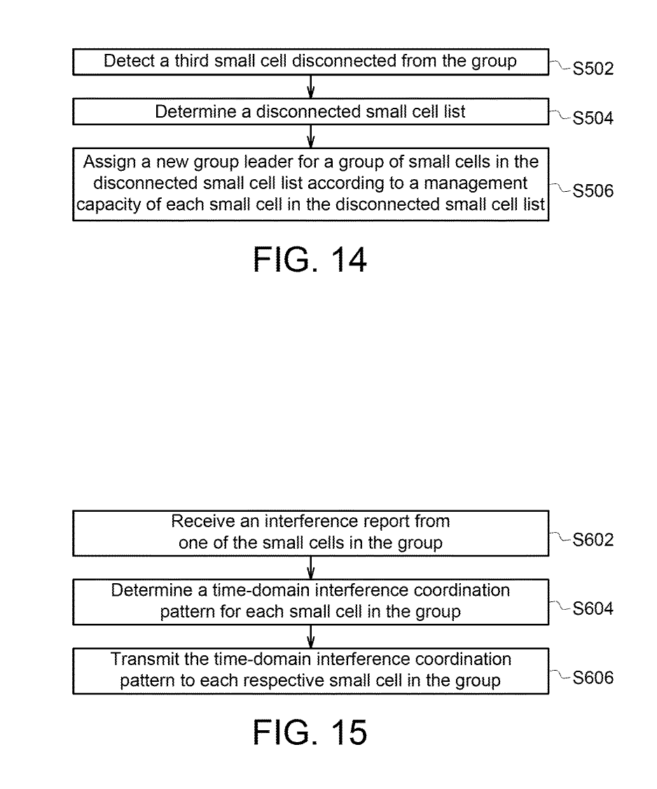

When one small cell in the group turns off or gets disconnected from other cells, the connection topology in the group has to be updated. In some cases, the lost connection of one specific cell may result in group splitting. FIGS. 13A and 13B show a process of splitting one group into two groups according to an embodiment of this disclosure. FIG. 14 shows a process of group splitting according to an embodiment of this disclosure. The group splitting process is also part of the group forming process (step S102). The group splitting process includes: detecting a third small cell disconnected from the group (step S502), determining, by the group leader, a disconnected small cell list comprising at least the third small cell (step S504), and assigning, by the group leader, a new group leader for a group of small cells in the disconnected small cell list according to a management capacity of each small cell in the disconnected small cell list (step S506).

Refer to FIG. 13A and FIG. 13B for a practical example. Initially all the seven small cells shown in FIG. 13A are in the same group. HeNB is the group leader. Step 1: HeNB D detects that HeNB C is not responding (probably being turned off). The neighbor relation between HeNB C and HeNB D is disconnected. Step 2: HeNB D sends a configuration update request (HeNB C is no longer a neighbor) to the group leader, HeNB B. Step 3: HeNB B determines a disconnected small cell list according to the connection topology. In this example, after HeNB C is disconnected, HeNB A and HeNB E are also disconnected. The disconnected small cell list includes HeNB A and HeNB E. Step 4: HeNB B obtains the management capacity of HeNB A and HeNB E. Step 5: HeNB B assigns HeNB A as a new group leader for the group of small cells in the disconnected small cell list. HeNB B tells the new group leader HeNB A the members of this newly formed group. Step 6: HeNB A notifies HeNB E to update the group leader as HeNB A. After splitting, two separate groups are formed, as shown in FIG. 13B, and HeNB A becomes a new group leader for the newly formed group.

The description above is related to forming groups in a distributed SON. After the groups are formed, time-domain interference coordination is performed within the group (step S106 in FIG. 3). FIG. 15 shows a process of performing time-domain interference coordination on the group according to an embodiment of this disclosure. The time-domain interference coordination may include: receiving an interference report from one of the small cells in the group (step S602), determining a time-domain interference coordination pattern for each small cell in the group (step S604), and transmitting the time-domain interference coordination pattern to each respective small cell in the group (step S606). Note that each step is performed by the group leader, for example, executed by the processing unit 110 of the group leader. The interference report may be generated by a small cell in the group, and interference may be detected by a UE between two neighboring small cells.

Determining a time-domain interference coordination pattern for each small cell in the group (step S604) may include: arranging the small cells in the group in an ordered list, and determining the time-domain interference coordination pattern for each small cell one by one in the ordered list according to a loading parameter of each small cell and a connection topology of the small cells in the group. In one embodiment, the ordered list is arranged according to the time that each small cell is added to the group. In another embodiment, the ordered list is arranged according to the number of neighbors of each small cell. In still another embodiment, the ordered list is arranged according to the loading parameter of each small cell.

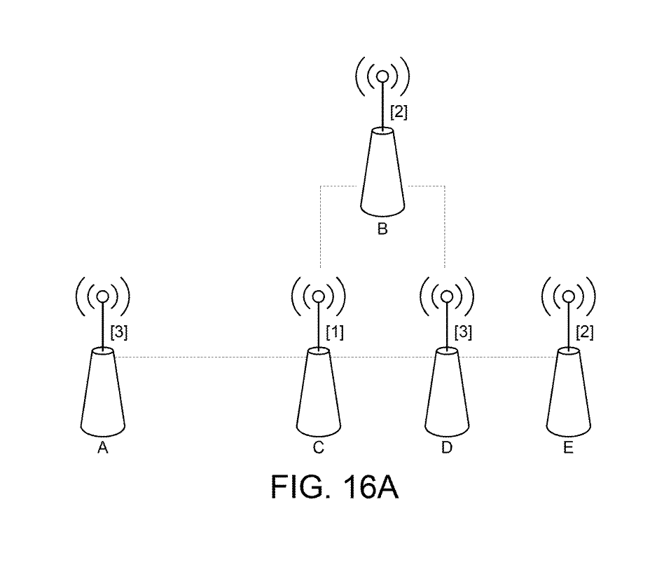

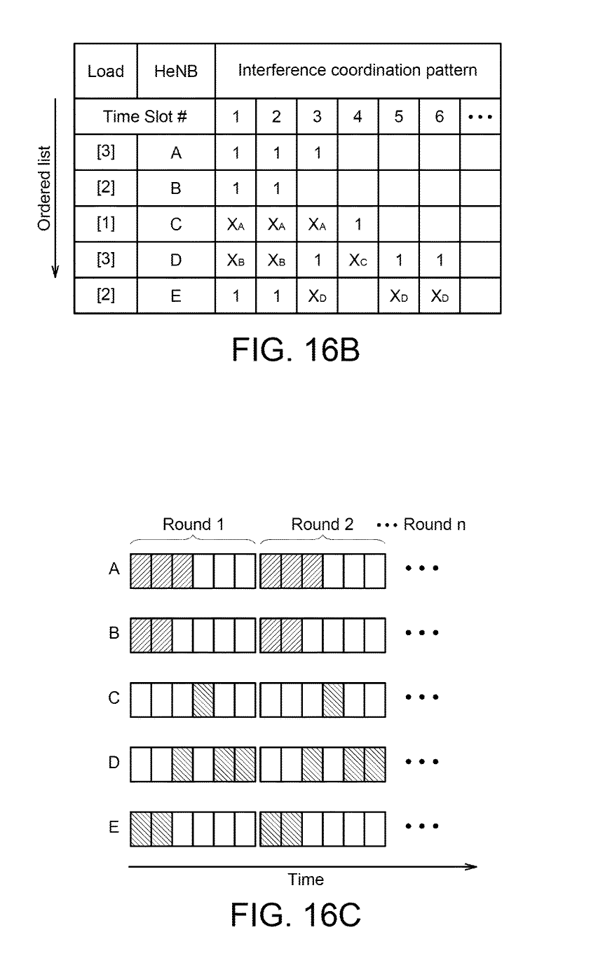

FIGS. 16A-16C show an example of determining time-domain interference coordination patterns according to an embodiment of this disclosure. As shown in FIG. 16A, there are five small cells, HeNB A-HeNB E, in the group in this example. HeNB B is the group leader. The dashed lines represent the neighboring relations between small cells. The numbers in the brackets represent the loading parameter of each small cell. The loading parameter may be related to how many UEs this small cell is serving or the traffic demand of this small cell. The ordered list in this example is {A-B-C-D-E}, which is arranged according to the time that each small cell is added to the group. The group leader HeNB B knows the connection topology in the group and all the loading parameters.

Refer to FIG. 16B, the interference coordination pattern is assigned one-by-one in the order of {A-B-C-D-E}. The number of time slots assigned to one small cell is based on the loading parameter of that small cell. HeNB A is first assigned time slots #1-#3 because its loading parameter is 3. HeNB B is then assigned time slots #1-#2 because its loading parameter is 2 and HeNB B does not neighbor HeNB A. As for HeNB C, because HeNB C neighbors HeNB A, time slots assigned to HeNB A cannot be assigned to HeNB C. In this example, HeNB C is assigned time slot #4. Next, because HeNB D neighbors HeNB B and HeNB C, HeNB D is assigned time slots #3, #5, #6 to avoid collision with HeNB B or HeNB C. HeNB E only neighbors HeNB D, and thus HeNB E is assigned time slots #1, #2.

In this example, six time slots are required for these five small cells. After the interference coordination pattern is determined, the group leader HeNB B transmits the interference coordination pattern to each respective small cell, such that each small cell can transmit data at appropriate timing to avoid interference. For example, HeNB A transmits data in time slots #1-#3 (interference coordination pattern=111000), HeNB D transmits data in time slots #3, #5, #6 (interference coordination pattern=001011), and so on. As shown in FIG. 16C, six time slots form a data transmission cycle. The small cells in this group can transmit data following this pattern repeatedly for every six time slots. When the group leader HeNB B receives another interference report, the group leader HeNB B may determine another interference coordination pattern for the group members.

The procedure of the determination of the interference coordination patterns as described above may be written as the following pseudo code:

1. Pop cell s from the ordered list S. Put cell s in the set P.

S←S−{s};P←P+{s}

2. Intersect T(s) with P, T(s): neighbors of cell s

Q(s)←T(s)∩P

3. Union of interference patterns from neighbors so far

a(s)=∪_{qεQ(s)}{A(q)}

4. Determine A(s), such that |a(s)∩A(s)|=0 and |A(s)|=L(s),
L(s): loading parameter of cell s

### 5. A←A(s)

6. Repeat steps 1-5 until the ordered list S is empty.

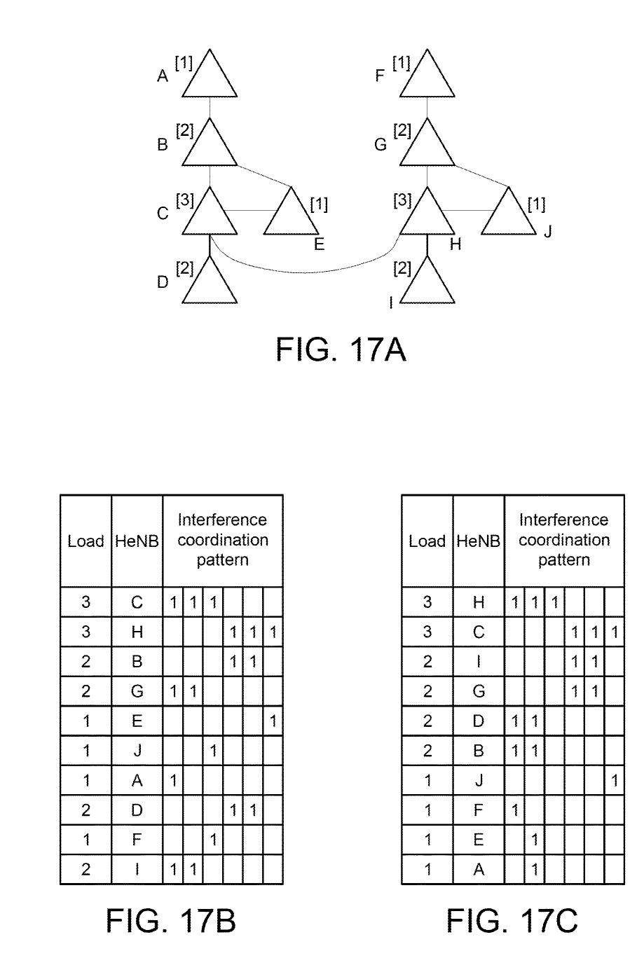

FIGS. 17A-17C show an example of determining time-domain interference coordination patterns according to different assignment orders. Notation in FIG. 17 is similar to FIG. 16, each triangle represents a small cell, numbers in the brackets represent the loading parameter of each small cell, and lines connecting small cells represent the neighboring relation. The ordered list shown in FIG. 17B is arranged according to the number of neighbors of each small cell. For example, HeNB C and HeNB H have the most neighbors (four) and hence are in the top of the ordered list, while HeNB A, D, F, I have the least neighbors (one) and are in the bottom of the ordered list. FIG. 17B shows the interference coordination pattern following the assignment order {C-H-B-G-E-J-A-D-F-I}.

On the other hand, the ordered list shown in FIG. 17C is arranged according to the loading parameters of each small cell. The small cells are ordered in descending order according to their loading parameter. FIG. 17C shows the interference coordination pattern following the assignment order {H-C-I-G-D-B-J-F-E-A}. The interference coordination pattern P1 obtained from FIG. 17B and the interference coordination pattern P2 obtained from FIG. 17C may be different. For example, for HeNB G, P1={110000}, P2=1000114 However, as long as each small cell uses a consistent pattern (for example, either each small cell uses the pattern P1 from FIG. 17B or each small cell uses the pattern P2 from FIG. 17C), interference can be avoided effectively. According to the interference coordination pattern determination method in this disclosure, once the ordered list is determined, the corresponding interference coordination pattern can be determined by the processing unit of the group leader and can be broadcasted to each small cell in the group. Ordering the small cells according to the number of neighbors or the loading parameter may help reducing the total number of time slots required for the interference coordination pattern.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for distributed interference coordination, comprising:
forming a group of a plurality of small cells;
selecting one of the small cells to be a group leader for the group; and
performing, by the group leader, time-domain interference coordination on the group.

2. The method according to claim 1, wherein the forming the group of small cells comprises:
detecting a neighbor relation between a first sub group and a second sub group, wherein each of the first sub group and the second sub group comprises at least one small cell; and
merging the first sub group and the second sub group into the group.

3. The method according to claim 2, wherein the selecting one of the small cells to be the group leader for the group comprises:
identifying a first sub group leader of the first sub group and a first management capacity of the first sub group leader;
identifying a second sub group leader of the second sub group and a second management capacity of the second group leader; and
selecting one of the first sub group leader and the second sub group leader to be the group leader according to the first management capacity and the second management capacity.

4. The method according to claim 3, wherein if the first management capacity is larger than both the second management capacity and the number of the small cells in the group, the first sub group leader is selected to be the group leader; and
if the second management capacity is larger than both the first management capacity and the number of the small cells in the group, the second sub group leader is selected to be the group leader.

5. The method according to claim 2, wherein the detecting the neighbor relation between the first sub group and the second sub group comprises:
detecting, by a user equipment, a second small cell in the second sub group; and
receiving, by a first small cell in the first sub group, a report of detecting the second small cell from the user equipment, wherein the first small cell is an original serving cell of the user equipment.

6. The method according to claim 1, wherein the performing time-domain interference coordination on the group comprises:
receiving an interference report from one of the small cells in the group;
determining a time-domain interference coordination pattern for each small cell in the group; and
transmitting the time-domain interference coordination pattern to each respective small cell in the group.

7. The method according to claim 6, wherein the determining the time-domain interference coordination pattern for each small cell in the group comprises:
arranging the small cells in the group in an ordered list; and
determining the time-domain interference coordination pattern for each small cell one by one in the ordered list according to a loading parameter of each small cell and a connection topology of the small cells in the group.

8. The method according to claim 7, wherein the ordered list is arranged according to a number of neighbors of each small cell.

9. The method according to claim 7, wherein the ordered list is arranged according to the loading parameter of each small cell.

10. The method according to claim 1, wherein the forming the group of small cells in a distributed manner comprises:
detecting a third small cell disconnected from the group;
determining, by the group leader, a disconnected small cell list comprising at least the third small cell; and
assigning, by the group leader, a new group leader for a group of small cells in the disconnected small cell list according to a management capacity of each small cell in the disconnected small cell list.

11. A small cell, comprising:
a backhaul interface, for connecting the small cell to a core network;
an air interface, for connecting the small cell to a user equipment;
a processing unit, for configuring the small cell in a group in a distributed manner, determining a group leader for the group, and performing time-domain interference coordination on the group, wherein the group comprises a plurality of small cells; and
a storage unit, for storing the group leader, a number of small cells in the group, a management capacity of the small cell, and a member list of the group.

12. The small cell according to claim 11, wherein when the small cell receives a report of detecting a neighbor small cell in a neighbor group, the group and the neighbor group are merged into a merged group.

13. The small cell according to claim 12, wherein the small cell receives the report of detecting the neighbor small cell in the neighbor group from the user equipment via the air interface.

14. The small cell according to claim 12, if the small cell is not the group leader of the group, the small cell notifies the group leader via the backhaul interface to coordinate with a neighbor group leader of the neighbor group to determine a merged group leader for the merged group.

15. The small cell according to claim 12, if the small cell is the group leader of the group, the small cell coordinates with a neighbor group leader of the neighbor group via the backhaul interface to determine a merged group leader for the merged group.

16. The small cell according to claim 15, wherein when the small cell coordinates with the neighbor group leader, the processing unit determines the merged group leader according to a number of small cells in the merged group, a management capacity of the small cell, and a management capacity of the neighbor group leader.

17. The small cell according to claim 16, wherein if the management capacity of the small cell is greater than both the management capacity of the neighbor group leader and the number of small cells in the merged group, the processing unit determines the small cell to be the merged group leader.

18. The small cell according to claim 17, wherein when the small cell is determined to be the merged group leader, the processing unit updates the number of small cells in the group and the member list of the group stored in the storage unit according to the neighbor group.

19. The small cell according to claim 11, wherein the processing unit further arranges the small cells in the group in an ordered list, and determines the time-domain interference coordination pattern for each small cell one by one in the ordered list according to a loading parameter of each small cell and a connection topology of the small cells in the group.

20. The small cell according to claim 19, wherein the ordered list is arranged according to a number of neighbors of each small cell.

21. The small cell according to claim 19, wherein the ordered list is arranged according to the loading parameter of each small cell.
